(19) United States
(12) Patent Application Publication
(10) Pub. No.: US 2018/0370333 A1
(43) Pub. Date: Dec. 27, 2018

(54) AIR CONDITIONING DEVICE FOR USE IN AN AIR FLOW PATH OF AN AIR CONDITIONING SYSTEM IN A MOBILE DEVICE

(71) Applicants: Ulrich Stahl, Laudenbach (DE); Volker Braeunling, Heppenheim (DE)

(72) Inventors: Ulrich Stahl, Laudenbach (DE); Volker Braeunling, Heppenheim (DE)

(21) Appl. No.: 15/905,869

(22) Filed: Feb. 27, 2018

(30) Foreign Application Priority Data
Jun. 26, 2017 (EP) 17 177 848.3

(51) Int. Cl. B60H 3/00

(52) U.S. Cl. CPC B60H 3/0028; B60H 2003/0042

(57) ABSTRACT

An air treatment device for an airflow of an air conditioning system includes a treatment element having one or more passages extending in part or completely in a flow direction. The passages include fragrancing faces that extend in the flow direction and are designed to release one or more fragrant substances into an airflow that is flowing through.

### CROSS-REFERENCE TO PRIOR APPLICATION

Priority is claimed to European Patent Application No. EP 17 177 848.3, filed on Jun. 26, 2017, the entire disclosure of which is hereby incorporated by reference herein.

### FIELD

The invention relates to air treatment devices to be arranged in an airflow for air-conditioning an interior space, in particular a passenger compartment of a mobile apparatus such as a motor vehicle.

### BACKGROUND

Air treatment devices can be used to provide air-conditioning air with a scent before said air is conveyed into an interior space. An air treatment device of this kind often comprises a nonwoven fabric that is impregnated with a fragrant substance and is arranged in the flow path. In this case, a fan conveys the airflow through the nonwoven fabric towards the interior space.

The capacity of a nonwoven fabric impregnated with a fragrant substance is very limited, and therefore the effect of the fragrance can last only for a short time. It is also not possible to control the intensity of the fragrancing using this system. The fragrancing effect therefore diminishes considerably over time.

Furthermore, air treatment devices of this kind constitute flow resistance which reduces the flow rate of the airflow and necessitates higher electric fan power for a specified air-conditioning airflow. However, this results in additional noise generation, which can be perceived as disruptive in the interior space.

Scent cartridges that are filled with granular fragrant substances and are arranged in the air ducts or in the pleats of an air filter, in the region of the flow, are also known. Said scent cartridges disturb the air conduction, generate undesirable air turbulences and can likewise cause an increase in flow noise.

In general, fragrancing of the air-conditioning air is provided by means of an additional air treatment device, which requires additional space in the air conditioning system and entails additional outlay during assembly.

### SUMMARY

In an embodiment, the present invention provides an air treatment device for an airflow of an air conditioning system, comprising: a treatment element having one or more passages extending in part or completely in a flow direction, the passages comprising fragrancing faces that extend in the flow direction and are configured to release one or more fragrant substances into an airflow that is flowing through.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic view of an air conditioning system for an interior space; and

FIGS. 2a and 2b are detailed views of a possible embodiment of a treatment device in side view and in cross-section;

FIG. 3 is a detailed view of a cross section of a further treatment device;

FIG. 4 is a cross section of a further treatment element; and

FIGS. 5a and 5b are a cross section of a nonwoven fabric as the treatment element and an enlarged sectional view through the nonwoven fabric.

### DETAILED DESCRIPTION

In an embodiment, the present invention provides an air treatment device for an air conditioning system.

According to a first aspect, an air treatment device for an airflow of an air conditioning system is provided, comprising an air treatment element having one or more passages extending in a flow direction of air-conditioning air, the passages comprising fragrancing faces extending in the flow direction which are designed to release one or more fragrant substances to an airflow that is flowing through.

A concept of the above-mentioned air treatment device consists in simultaneously achieving flow rectification, fragrancing, ozone reduction and a noise-reducing effect. In this case, the air treatment device is a component to be inserted in an air conditioning system, which component substantially comprises a single element which can treat the air-conditioning air. For this purpose, the air treatment device substantially comprises an air treatment element having fragrancing faces which extend along the flow direction and are enriched with a fragrant substance such that, when air-conditioning air flows through, said air is enriched with the fragrant substance.

Providing as large as possible a surface area over which the airflow passes, allows noise generated upstream, such as noise from a fan, to be refracted by a large number of sound reflection surfaces so that considerable noise reduction can be achieved without additional noise being produced by the air-conditioning air flowing along the fragrancing faces. Furthermore, the airflow can be rectified by a parallel arrangement of the fragrancing faces along the course of said flow in order to achieve a laminar flow path when the air-conditioning air enters the interior space. Arranging the fragrancing faces in this way also results in lower flow resistance, which in turn leads to lower noise generation in the air conditioning system. The ozone in the air-conditioning air is also reduced because of the large surface along which the air-conditioning air flows.

Flow rectification, fragrancing, ozone reduction and a noise-reducing effect can thus all be achieved by the air treatment device using one common component.

According to an embodiment, the treatment element can comprise a nonwoven fabric, in particular a spunbonded nonwoven or a staple fiber nonwoven, and at least one of the fragrant substances can be embedded in the fibers of the nonwoven fabric.

The treatment element can further comprise a multicomponent nonwoven, in particular a spunbonded nonwoven or a staple fiber nonwoven, the multicomponent nonwoven comprising fibers which have a core region and an outer region surrounding the core region. The core region and the outer region differ in their chemical and/or physical properties. At least one of the fragrant substances is embedded only in the outer region of the fibers of the nonwoven fabric.

Furthermore, the passages of the treatment element can have a honeycomb-shaped, circular, oval, rectangular and polygonal cross section.

It is possible for the treatment element to have a cross section formed by planar slats, and in particular a stellate cross section.

According to an embodiment, the treatment element can be made of a plastics material, at least one of the fragrant substances being introduced as an encapsulated fragrant substance into a polymer matrix of the relevant plastics material of the element body of the treatment element.

According to a further embodiment, the air treatment element can comprise a multicomponent plastics material, at least one of the fragrant substances being introduced as an encapsulated fragrant substance into a polymer matrix of the first plastics material of the element body of the air treatment element, the first plastics material being deliberately arranged on the surface of the fragrancing faces of the air treatment element and at least one second plastics material (i.e. a different plastics material, a different material structure or the like, for example) being attached in the core of the treatment element. Arranging the fragrant substance close to the surface improves the release into the airflow and can reduce the amount of fragrant substance used.

The air treatment element may be provided with a heating device in order to control the rate of release of the one or more fragrant substances by heating the treatment element.

In particular, the concentration of the fragrant substance released into the airflow can be set by the partial pressure difference/concentration of the fragrant substance inside the element relative to the surrounding atmosphere, and by the temperature gradient between the element and the surroundings.

### Description of Embodiments

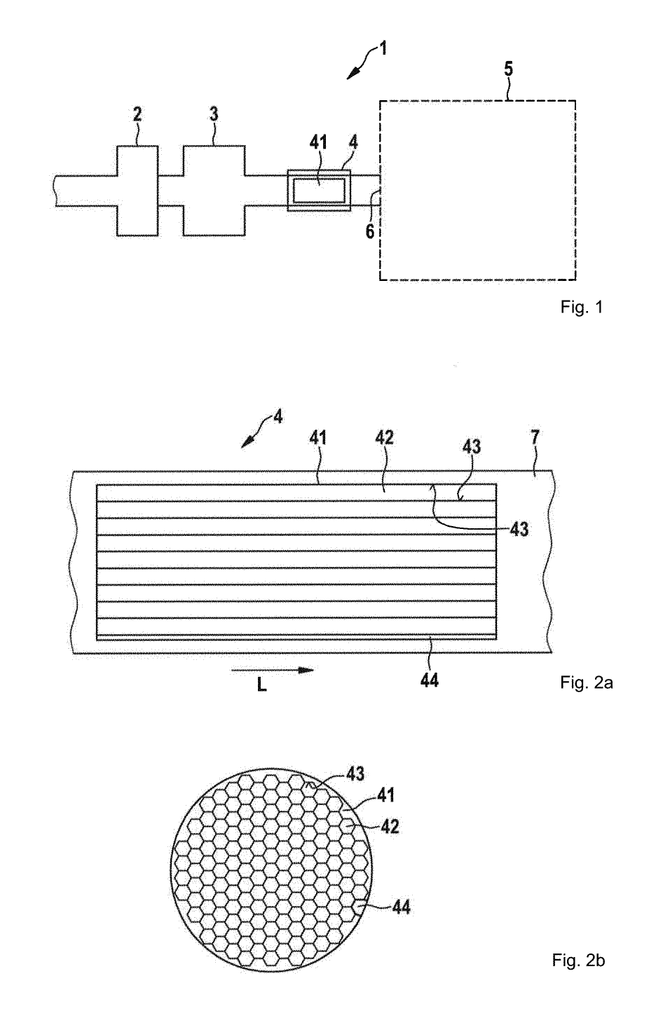

FIG. 1 is a schematic view of an air conditioning system 1 for an interior space, for example a passenger compartment of a motor vehicle or the like. The air conditioning system 1 comprises a fan 2 for sucking in fresh air from the surroundings and for providing an airflow which is subsequently guided through a heat exchanger 3 in order to heat or cool the air-conditioning air.

Downstream of the heat exchanger 3, an air treatment device 4 is arranged in the airflow before the airflow enters the interior space 5. In particular, the air treatment device 4 is arranged directly on an air outlet 6 or as close as possible to the air outlet 6, in the interior space 5, and can be arranged in the airflow so as to be exchangeable.

FIGS. 2a and 2b are different views of an air treatment device 4 by way of example. FIG. 2a is a sectional view along the longitudinal direction L which corresponds to the flow direction of the air-conditioning air. FIG. 2b is a corresponding cross section. FIG. 2a shows the air treatment device 4 comprising a treatment element 41 which is arranged in a flow path 7 of the air conditioning system 1. The treatment element 41 comprises a plurality of passages 42 which extend along the flow path 7 and the inner surfaces of which extend substantially in parallel with one another. The inner surfaces of the passage 42 can be entirely or in part designed as fragrancing faces 43.

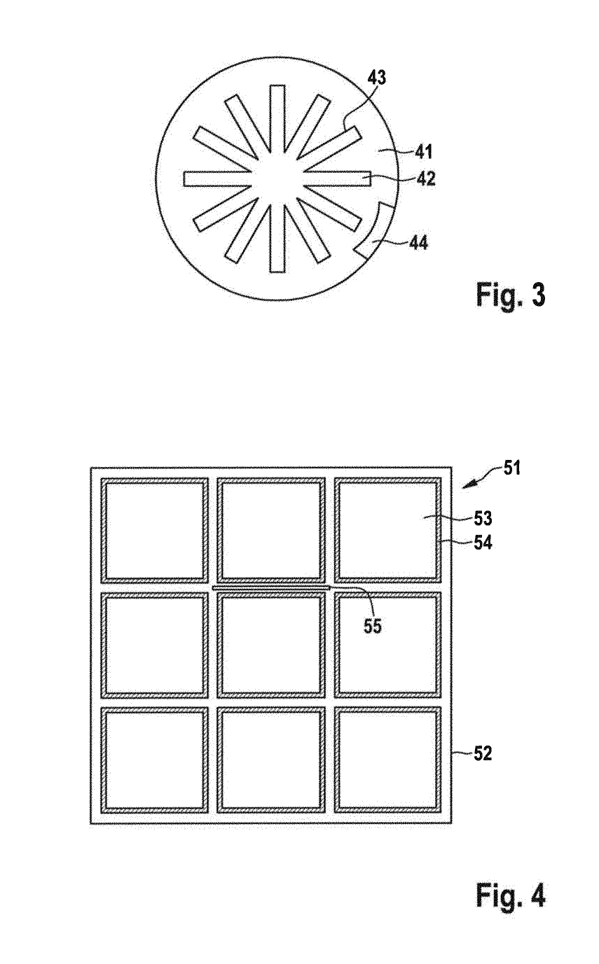

Instead of the channel structure, the element body of the treatment element 41 can also comprise slats arranged in the flow path, for example slats 42 arranged in a stellate manner, as shown in the cross section in FIG. 3, the outer surfaces of which extend in parallel with the flow path and are entirely or in part designed as fragrancing faces 43.

In the region of fragrancing faces 43, a fragrant substance can be applied to the surfaces or said surfaces can contain encapsulated fragrant substances.

In cross-section, the passages 42 of the treatment element 41 can have a honeycomb-shape, a circular cross section or another cross-sectional shape. The treatment element 41 can have a length of between 1 and 10 cm in the flow direction. In particular, the ratio of the cross-sectional area Q [cm²] to the length L [cm] of the treatment element 41 can be L/Q=0.1 or less.

FIG. 4 shows, as an example, a cross section of a further treatment element 51 which is formed as a multicomponent injection-molded plastics element. Said element comprises an element core 52 which is made of a first plastics material and is not, or is only in part, provided with fragrant substances. The element core 52 comprises passages 53 which have a quadratic cross section in the present embodiment, but are not limited to this cross-sectional shape. Other suitable cross-sectional shapes can therefore also be provided and expedient.

The surfaces in the passages 53 are provided with a coating 54 or a layer comprising a second plastics material. The second plastics material is provided with fragrant substances in one of the manners described above, at least one of the fragrant substances being provided only in the second plastics material. The at least one fragrant substance can thus be positioned close to the surface, which can improve the efficiency of the use of the at least one fragrant substance.

The element body of the treatment element 41 can be produced from a material made predominantly of a plastics material, such as PP, PES, PA and the like. In particular the surfaces of the air treatment element 41 are provided with one or more fragrant substances which can be released into the airflow that is flowing through. For this purpose, the fragrant substance or fragrant substances can be introduced as encapsulated fragrant substances into the polymer matrix of the relevant plastics material of the element body. The fragrant substances are released therefrom into the airflow over time and carried into the interior space 5 along with said airflow.

Commercially available “aromatic” substances are used as fragrant substances, which substances are introduced in encapsulated form into the material structure of the element in a shaping process (injection molding, extrusion or fiber spinning, for example) during the process for producing the element body. Coumarin, benzylideneheptanal, limonene, eugenol, 2-phenylethyl alcohol, heliotropin, vanillin, muscone and maltol, for example, can be used as fragrant substances.

The even distribution, in the element body, of the fragrant substances encapsulated in a polymer matrix is determined by the production process, in this case in particular the injection-molding process or extrusion process in the case of a honeycomb element, or the fiber-spinning process in the case of a nonwoven element.

The discharge of the fragrant substance or fragrant substances from the surfaces of the passages 42 or from the material of the treatment element 41 can be controlled by a controllable heating device 44, the concentration of the fragrant substance increasing at higher temperatures. The heating device 44 can preferably be designed as an electric heating device, which can in particular be temperature-controlled. The heating device 44 can be provided on the edge of the element body or in the center of the element body, preferably extending along the length of the element body.

Designing the treatment element 41 so as to have a plurality of individual passages 42 allows the surface along which the airflow of the air-conditioning air passes to be considerably enlarged, with the result that it is easier for fragrant substances to be absorbed from the element body.

Furthermore, a large surface along which the airflow of the air-conditioning air passes results in a reduction in the amount of ozone contained in the air-conditioning air that is flowing through, which ozone is usually reduced by contact with any surface.

Flow rectification is also achieved, in that turbulences in the airflow are reduced and the airflow exiting on the output side of the air treatment device 4 is laminarized. This reduces the flow noise on the output side of the air treatment device 4.

FIG. 4 shows, as an example, a cross section of a further treatment element 51 which is formed as a multicomponent injection -molded plastics element or an element produced by multicomponent extrusion. Said element comprises an element core 52 that is made of a first plastics material and is not provided with fragrant substances. The element core 52 comprises passages 53. The passage 53 have a rectangular cross section in the present embodiment. The passages 53 for the multicomponent plastics element can also have other cross sections.

The surfaces in the passages 53 are provided with a coating 54 or a layer comprising a second plastics material. The second plastics material is provided with fragrant substances in one of the manners described above. The fragrant substances can thus be placed close to the surface, which can improve the efficiency of the use of fragrant substances.

A heating device 55 as described above can be embedded in the element core 52.

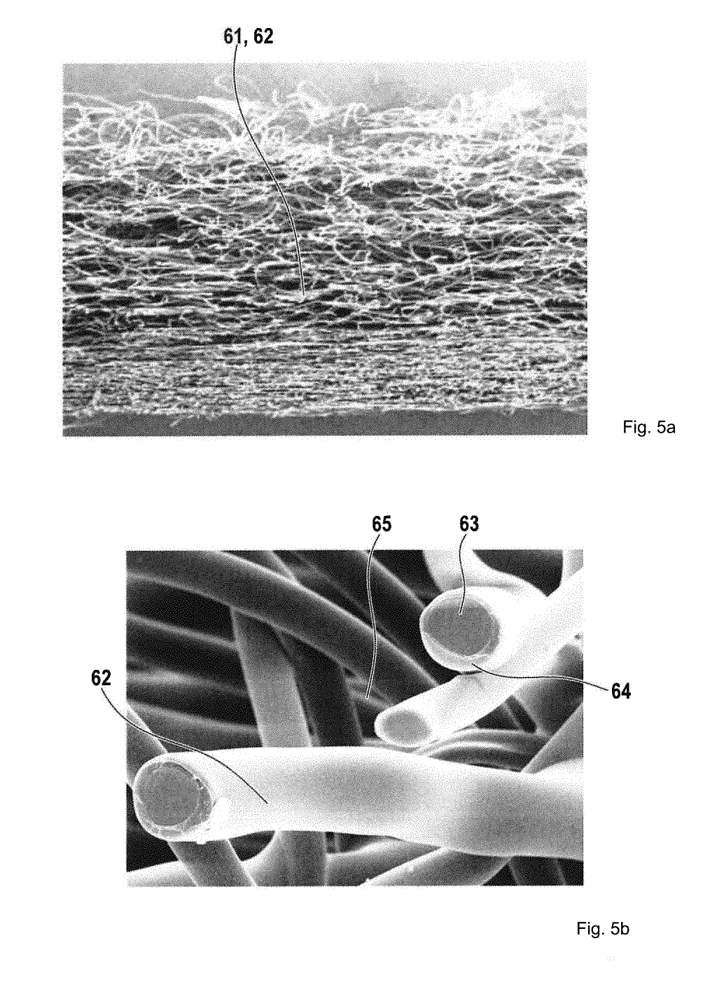

FIG. 5 shows, as an example, a cross section of a further treatment element 61 which is formed as a multicomponent nonwoven element. The multicomponent nonwoven element 61 consists of fibers 62 comprising an element core 63 which is made of a first plastics material and is not, or is only in part, provided with fragrant substances. In the cross-sectional view of the fiber, the second plastics material 64 is shown as an outer casing which completely surrounds the fibers 62. Alternatively, the second plastics material may cover the fibers 62 only in part, i.e. not completely. The fragrancing faces in the passages 65 correspond to the surface or surfaces of the element core 63 covered by the second plastics material 64, which surfaces are coated with the second plastics material. The second plastics material 64 is provided with fragrant substances in one of the manners described above. The fragrant substances can thus be positioned close to the surface, which can improve the efficiency of the use of fragrant substances.

The passages 65 of the treatment element 61 can be arranged so as to be non-homogenous and variable in cross-section, and correspond to the free spaces between the fibers. The treatment element 61 can have a length of between 1 and 5 cm in the flow direction. In particular, the ratio of cross-sectional area Q [cm²] to the length L [cm] of the treatment element 61 can be L/Q=0.05 or less.

The multicomponent nonwoven element can consist of one or more plastics materials from the material classes PP, PES, PET, PA and PBT, it also being possible for the first and the second plastics materials to also differ not only in their physical properties, such as temperature resistance, melting point or softening point.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 air conditioning system

2 fan

3 heat exchanger

4 air treatment device

5 interior space

6 air outlet

41 treatment element

42 passages

43 fragrancing faces

44 controllable heating device

51 treatment element

52 element core

53 passages

54 coating

55 heating device

61 treatment element

62 fibers

63 fiber core

64 outer region of fiber

65 passages

7 flow path

What is claimed is:

1. An air treatment device for an airflow of an air conditioning system, comprising:
a treatment element having one or more passages extending in part or completely in a flow direction, the passages comprising fragrancing faces that extend in the flow direction and are configured to release one or more fragrant substances into an airflow that is flowing through.

2. The air treatment device according to claim 1, wherein the treatment element comprises a nonwoven fabric, in particular a spunbonded nonwoven or a staple fiber nonwoven, and at least one of the fragrant substances is embedded in the fibers of the nonwoven fabric.

3. The air treatment device according to claim 1, wherein the treatment element comprises a multicomponent nonwoven, in particular a spunbonded nonwoven or a staple fiber nonwoven,
wherein the multicomponent nonwoven comprises fibers that have a core region and an outer region surrounding the core region, which regions differ in their chemical and/or physical properties, and
wherein at least one of the fragrant substances is embedded only in the outer region of the fibers of the nonwoven fabric.

4. The air treatment device according to claim 1, wherein the passages of the treatment element each have a honeycomb-shaped, circular, oval and polygonal cross section.

5. The air treatment device according to claim 1, wherein the treatment element has a cross section formed by planar slats, and in particular has a stellate cross section.

6. The air treatment device according to claim 4, wherein the treatment element comprises a plastics material, and at least one of the fragrant substances is introduced as an encapsulated fragrant substance into a polymer matrix of the relevant plastics material of the element body of the treatment element.

7. The air treatment device according to claim 4, wherein the treatment element comprises a multicomponent plastics material and at least one of the fragrant substances is introduced as an encapsulated fragrant substance into a polymer matrix of a first plastics material of the element body of the treatment element, and
wherein the first plastics material is arranged on the surface of the fragrancing faces of the treatment element and at least one second plastics material is applied in the core of the treatment element.

8. The air treatment device according to claim 1, wherein the treatment element is provided with a heating device configured to control a rate of release of the one or more fragrant substance by heating the treatment element.

9. An air conditioning system for an interior space, in particular a passenger compartment of a motor vehicle, comprising:
the air treatment device according to claim 1 arranged in an airflow of the air conditioning system.

10. The air conditioning system according to claim 9, wherein the air conditioning system comprises an air outlet, and
wherein the air treatment device is arranged upstream of the air outlet and is mounted so as to be exchangeable.
